(19) United States
(12) Patent Application Publication
(10) Pub. No.: US 2009/0158650 A1
(43) Pub. Date: Jun. 25, 2009

(54) GARDEN TOOL

(76) Inventor: Edward L. Johnson, Atlanta, GA (US)

Correspondence Address: MERCHANT & GOULD PC, P.O. BOX 2903, MINNEAPOLIS, MN, 55402-0903, US

(21) Appl. No.: 11/959,616

(22) Filed: Dec. 19, 2007

(51) Int. Cl. B25B 9/02; A01G 7/00

(52) U.S. Cl. 47/58.1 SE; 294/99.2

(57) ABSTRACT

An apparatus configured to facilitate removal of a growing medium and the root structure of a plant surrounded by the growing medium while maintaining the integrity of the growing medium and root structure. The apparatus comprises a U-shaped connector body having a first blade and a second blade extended down there from. The first blade has a first end and a second end to which the first end of the U-shaped connector body is connected. The connection of the first blade to the U-shaped connector body is at an angle causing the first blade to extend downward when the U-shaped connector body is positioned horizontally. The second blade has a first end and a second end to which the second end of the U-shaped connector body is connected. The connection of the second blade to the U-shaped body is at an angle causing the second blade to extend downward when the U-shaped connector body is positioned horizontally. The apparatus is configured such that the distance between the first and second blade may be decreased upon applying pressure to the first and second ends of the U-shaped connector body. Decreasing the distance between the first and second blades allows for the positioning of the blades to facilitate insertion of the first and second blades down a sidewall assembly of a container cell. During insertion of the first and second blades into a container cell, the first and second blades are positioned between the interior walls of the cell sidewall assembly and a growing medium that surrounds a plant root structure. Applying pressure to the first and second ends of the u-shaped connector causes the first and second blades to press against the growing medium and facilitate removal of the growing medium upon the lifting of the apparatus.

### FIELD OF INVENTION

The present invention relates to garden tools and more particularly to a garden tool for removing plant and flower root systems from a cell of a multi-plant/flower delivery device.

### BACKGROUND OF THE INVENTION

It is common procedure in commercial greenhouses and large-scale reforestation and farming operations to initially germinate and/or grow new plants in a controlled environment. Such environments increase the likelihood of the new plant's survival during the first few months of the plant's life. The new plants are typically maintained in the controlled environment until they reach a predetermined stage of development. Upon reaching this stage of development, the new plants are transported to a selected location where they are placed in the soil to continue their growth on a long-term basis.

Growing new plants in a controlled environment spatially removed from their intended long-term growing situs requires the plant grower to provide a temporary container for the new plant during its maturation in the greenhouse. Conventionally, new plants are grown in small plastic containers. These containers are oftentimes arranged in arrays or matrixes of individual cells and are known by designations such as pony packs, trays, flats, etc. Not only do these containers provide a means of retaining the new plant and its growing medium during the initial growth stages of the plant, but furthermore, these containers provide a means for transporting the new plant to its eventual long-term planting situs.

As the new plant develops, its root structure becomes enmeshed in the growth medium which surrounds it in its container. Disruption of that association of the root structure and its associated growth medium can prove damaging to the plant and its long-term survivability. In those instances wherein the container is manufactured of a nonbiodegradable material, the plant root structure must be removed from the container in order to plant the new plant in the soil of its long-term growth situs. Given the importance of maintaining the root structure in close association with the growth medium surrounding it in the container, it becomes important that the user be able to remove the root structure from the container with a minimum disruption of the root structure's association with its growth medium. Traditionally, users have encountered significant difficulties in safely removing the root structure from its respective container. In many instances, the user would grasp the plant by its stem and attempt to pull the plant root structure from the container. In the even that the growth medium or the root structure was securely lodged in the container, e.g., the growth medium being dry and fairly hard, the root structure of each seedling grows to an extent so as to fill the capacity of its container, it becomes difficult to dislodge the seedling from the pack or pot. In particular, the roots of the plant may become lodged and root-bound to the inside surface of the pack or pot, and therefore, the roots are liable to tearing and damage during removal from the packs or pots. In the previously described circumstances, as the user applied more force to the plant stem to secure the plant's removal from the container, he or she would oftentimes break the stem of the plant, thereby destroying the plant.

In those instances wherein the growth medium was very wet, grasping the stem and pulling on it would often result in the root structure being disassociated from its growth medium. This dissociation prejudices the chances of the plant surviving once it is planted in the soil. In other situations, the user would compress the container prior to extracting the plant root structure from the container with the expectation that the compression would ease the removal of the root structure from the container. In these instances, the compression resulted in damage to the root structure. It follows that considerable damage and loss of plants have occurred due to the lack of available means of safely removing the root structure and accompanying growth medium from its initial growth container.

Accordingly, there is a need to devise an arrangement for dislodging a plant root and its associated growth medium from containers of a size generally used without damaging the plant and further, to remove the plant in an efficient manner.

As such, it is important to ensure that the container arrangement offers sufficient facility and convenience to dislodge each plant together with its roots and growth medium in such a manner that detrimental separation of the growth medium from the roots does not occur at the time of transplantation. It is essential, especially in transplanting projects, to ensure that the survival chances of replanted plants are high, and root separation from the growth medium during transplanting is certain to be avoided.

In the past, various efforts have been made to provide containers that are configured for developing plants. Illustrative of these efforts are U.S. Pat. No. 3,667,159, U.S. Pat. No. 3,889,416, and U.S. Pat. No. 4,197,647. U.S. Pat. No. 3,667,159 teaches a unitary seedling “flat” made of rigid plastic and containing a plurality of cells in the form of square, downwardly tapering recesses. The seedling flat of this reference has no special facilities for releasing the seedlings together with their root balls. In U.S. Pat. No. 3,667,159, the seedlings have to be pulled out of the cells, offering no special advantages for safe and easy removal of the seedlings root balls, especially if the roots are lodged and root bound to the inside of the cells. U.S. Pat. No. 3,889,416 to Bergeron et al. teaches a seedling arrangement for reforestation purposes, containing a plurality of tubes adapted to be supported vertically in a tray. The tubes are intended for elevated growing, but contain no special provision or convenience for easily dislodging the seedling without damage and separation being inflicted on the root ball. In fact, the vertically extending ribs, provided on the inner cylindrical surface of the tubes in U.S. Pat. No. 3,889,416, tend to make the tubes rigid and stiff by reinforcing, whereby the tubes will not easily flex. As such, the rigid tubes necessitates rolling, pinching, or pulling action on the rigid container in order to release the seedling, making it very difficult to safely release the seedling together with the root ball and growth medium without damaging the seedling. In many cases, it may be necessary to tip the container upside down in an effort to remove the plant, resulting in root and/or plant damage and also loss of dirt which creates a mess.

In an effort to prevent damaging the root system while transplanting seedlings, U.S. Pat. No. 4,197,647 to Blackmore, Jr. discloses a plant container with a plurality of downwardly extending compartments, each made for containing the root ball and system of a seedling. The bottom end of the compartment is constructed of thin material and includes a slit to form yieldable flap members that can bend and reverse inwardly so that an ejection plunger can move upwardly there through to thereby eject the contents of the compartment.

U.S. Pat. No. 6,546,670 to Robert Bautner, a container structured to facilitate removal of the plant root structure and growth medium. The container has been modified so that it includes at least one upstanding stripped sidewall. The sidewall is configured to have a portion or slot thereof removed by applying a small manual force to the sidewall portion. The removable slot extends from a free edge of the sidewall into the body of the sidewall. The slot functions as a stress riser sufficient that upon the application of a modest amount of force to the sidewall proximate the slot, the sidewall may be made to rupture along a length, causing the sidewall to open up and thereby permit the user to safely remove the plant root structure and growth medium without the need of compressing the root structure and growth medium or applying inordinate force to the plant stem.

Based on the foregoing, there is a need for apparatus that may be used in combination with standard as pony packs, trays, flats, etc. that are not modified to include a stripped sidewall or any of the above mentioned modifications to facilitate removal of a young plant's root structure and associated growth medium from the container at the time of transplantation. Such an apparatus would also provide a means of minimizing the likelihood of the root structure being damaged or dissociated from its growth medium.

### BRIEF SUMMARY OF THE INVENTION

An object of the present invention is to remove a growing medium and the root structure of a plant that it surrounds while maintaining the integrity of the growing medium and root structure. This object is carried out by the present invention which is an apparatus comprising u-shaped connector body connecting a first blade and a second blade. The first blade having a first end and a second end, wherein the second end of the first blade is connected to the first end of the u-shaped connector body at an angle whereby the first blade extends downward when the u-shaped connector body is positioned horizontally. The second blade having a first end and a second end, wherein the second end of the second blade is connected to the second end of the u-shaped connector body at an angle whereby the second blade extends downward when the u-shaped connector body is positioned horizontally. The first blade and the second blade have first ends having a thickness that gradually decreases in the direction towards the first ends of the first and the second blades so as to facilitate insertion of the first and second blades down a sidewall assembly. During insertion of the first and second blades into a container cell, the first and second blades are positioned between the interior walls of the cell sidewall assembly and a growing medium that surrounds a plant root structure. Applying pressure to the first and second ends of the u-shaped connector causes the first and second blades to press against the growing medium and facilitate removal of the growing medium upon the lifting of the apparatus which may be comprised of a flexible material such as a polymer or metal.

### BRIEF DESCRIPTION OF THE FIGURES

Non-limiting and non-exhaustive embodiments are described with reference to the following figures, wherein like reference numerals refer to like parts throughout the various views unless otherwise specified.

FIG. 1 depicts a perspective view of the present invention, an apparatus for removing a plant's root structure and growth medium;

FIG. 2 depicts a perspective view of an apparatus for removing a plant's root structure and growth medium, illustrating the how the apparatus is used with container cells;

FIG. 3 depicts a perspective view of an apparatus for removing a plant's root structure and growth medium, illustrating the apparatus positioned within a container cell;

FIG. 4 depicts a perspective view of an apparatus for removing a plant's root structure and growth medium, illustrating the apparatus positioned within a container cell; and

FIG. 5 depicts a perspective view of an apparatus for removing a plant's root structure and growth medium, illustrating the apparatus following removal of a plant's root structure and growth medium from a container cell.

### DETAILED DESCRIPTION

Various embodiments are described more fully below with reference to the accompanying drawings, which form a part hereof, and which show specific exemplary embodiments for practicing the invention. However, embodiments may be implemented in many different forms and should not be construed as limited to the embodiments set forth herein; rather, these embodiments are provided so that this disclosure will be thorough and complete, and will fully convey the scope of the invention to those skilled in the art. The implementation is a matter of choice dependent on the performance requirements and needs of the user implementing an embodiment.

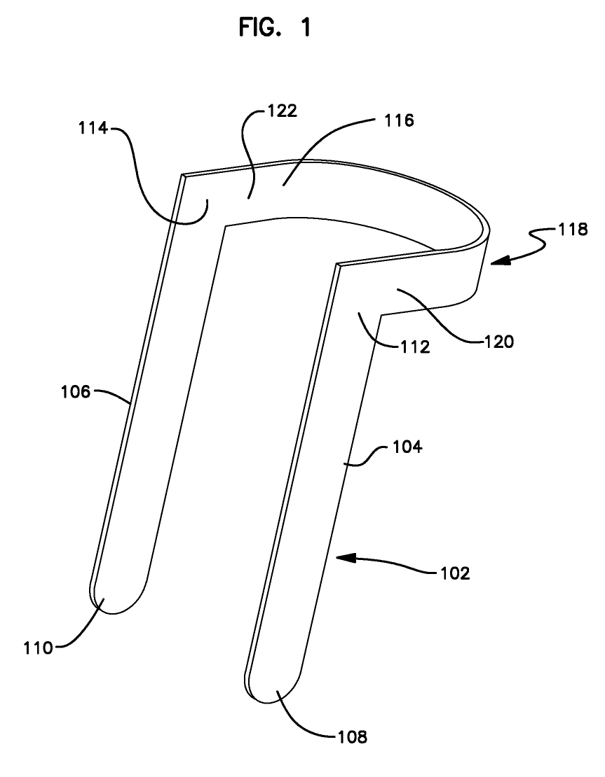

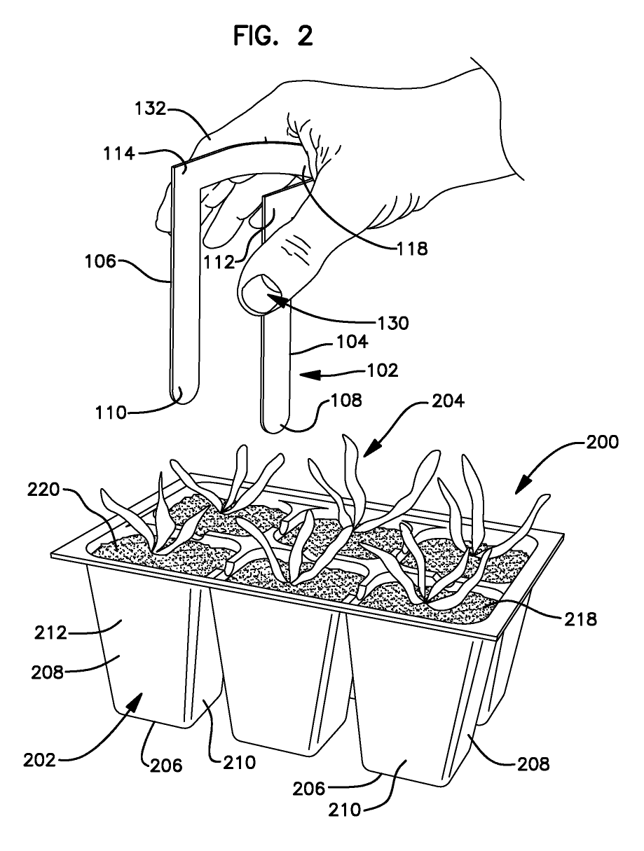

Referring to the drawings, FIG. 1 and FIG. 2 illustrate a perspective view of an apparatus 102 for removing a plant's root structure and growth medium from a plant tray 200. As illustrated in FIG. 2, the plant tray 200 has six cell containers 202, in a matrix arrangement of two cells in one direction and three cells in another direction (2×3). While the tray shown in FIG. 2 is illustrative, it should be understood that the apparatus 102 for removing a plant's 204 root structure (not shown) and growth medium may be applied to single containers as well as trays having any number of associated container cells 202. Each container cell 202 is particularly suited for germinating and/or growing plants 204 during their initial stages of development.

As shown, each container cell 202 may include a sidewall assembly 204 comprised of one or more sidewalls which extend upwardly from a bottom floor 206. Each sidewall within sidewall assembly 212 is secured to the bottom floor 206 and to adjacent sidewalls 208, 210 along its two opposing upstanding edges, thereby forming an open-topped container cell structure 202. Each container cell structure 202 is typically formed by four sidewalls 208, 210 terminating at the bottom floor 206. Further in some constructions, the sidewalls 204 may be formed from a single integral sheet of material. In an alternative construction, the container cell 202 may be formed of a single sidewall 204 and bottom wall 206 to thereby have the shape of a cylindrical cone.

As illustrated in FIGS. 1 and 2, the apparatus 102 has a first blade 104, a second blade 106, and a U-shaped connector 118 connecting the first and second blades 104 and 106. The first blade 104 has a first end 108 and a second end 112. The second blade 106 has a first end 110 and a second end 114. The U-shaped connector 118 has a first end 120 and a second end 122. The first end 120 of the U-shaped connector 118 is connected to the second end 112 of the first blade 104. The second end 122 of the U-shaped connector 118 is connected to the second end 114 of the second blade 106. In one embodiment, the U-shaped connector 118, the first blade 104 and the second blade 106 may be configured as a unitary body. In an alternative embodiment, the U-shaped connector 116, the first blade 104 and the second blade 106 are configured as separate components, connected in a stationary manner. As FIG. 2 illustrates, the U-shaped connector 116 is held in the hand of a user and gripped by a user with his or her thumb 130 and fore finger/middle finger 132. Upon applying pressure to the first and second ends 120, 122 of the U-shaped connector 118 with a thumb 130 and fore finger/middle finger 132, the distance between the first and second blades 104, 106 is decreased to allow the first and second blades 104, 106 to be separated by a distance sufficient to allow the first and second blades 104, 106 to extend down the interior side walls 220 of the container cell 202, between the sidewalls 220 and the growth medium 218 that surrounds a plant's root structure.

In one embodiment, the first and second blades 104, 106 have rounded first ends 108, 110 and are comprised of a thickness that gradually decreases in the direction of the first ends of the first and second blades 104, 106 so as to facilitate insertion of the first and second blades 104, 106 down the interior of sidewall assembly 212, whereby the first and second blades 104, 106 are between the interior walls of the side wall assembly 112 and the growing medium that surrounds a plant root structure.

As FIG. 1 illustrates, the first end 120 of the u-shaped connector body 118 and the second end 112 of the first blade 104 of the apparatus 102 are connected at an angle whereby the first blade 104 extends downward when the u-shaped connector body is positioned horizontally. The second end 122 of the u-shaped connector body 118 and the second end 114 of the second blade 106 of the apparatus 102 are connected at an angle whereby the second blade 106 extends downward when the u-shaped connector body 118 is positioned horizontally. First and second blades 104, 106 are connected to the u-shaped connector body 118 so that the blades 104, 106 are substantially in parallel. In an alternative embodiment, the first and second blades 104, 106 are connected to the u-shaped connector body so that blades 104, 106 are angled inward at an angle consistent with the sidewall assembly of a container cell.

In one embodiment, the angle between the first and second blades 104, 106 and the u-shaped connector body 118 may be ninety degrees. In another embodiment the angle between the first and second blades 104, 106 and the u-shaped connector body 118 may be close to a right angle. However, it is to be understood that the u-shaped connector body 118 and the first and second blades 104, 106 may be connected in such a manner where there is no angle and the u-shaped connector body 118 extends vertically when the apparatus 102 is being used. The apparatus 102 is comprised of a material having flexibility that allows for a reduction in space between the first and second blades 104, 106 upon the application of pressure to the first and second ends 120, 122 of the u-shaped connector. In one embodiment, the apparatus is comprised of a metal. In another embodiment, the apparatus is comprised of a polymer.

In one embodiment, the apparatus 102 may be formed of a ⅝ inch wide strip that is approximately 12 inches long. The blade 104, 106 of the apparatus 102 may be comprised of metal or any other material that substantially stiff. The u-shaped connector body 118 is configured as a semi-circular bow which is slightly flexible. In one embodiment, the semi-circular bow has a two inch diameter. It is contemplated that the semicircular bow may be of a size to facilitate removal of plants for container cells.

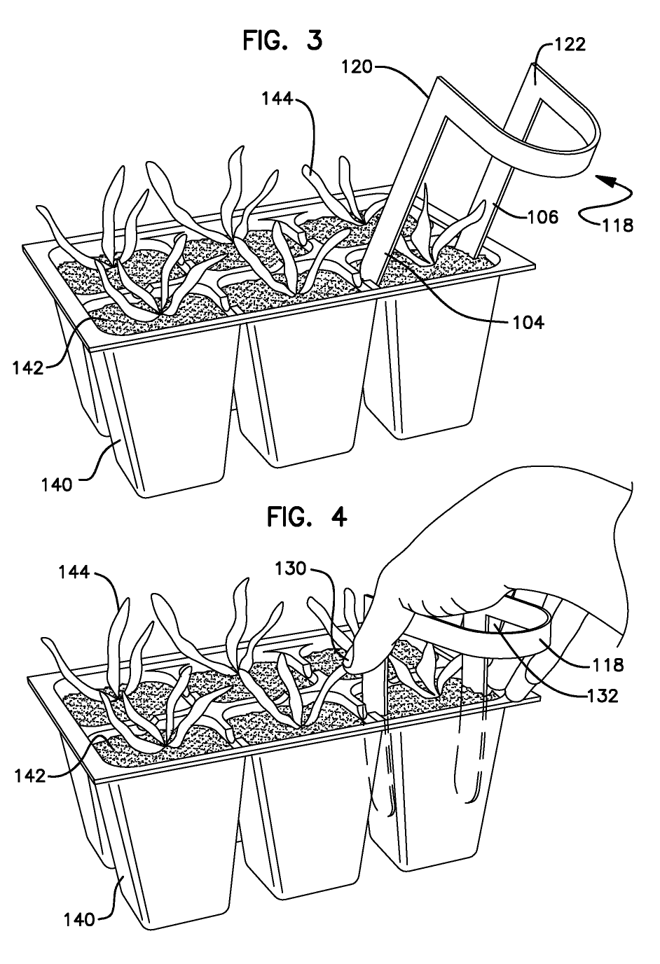

As illustrated in FIGS. 3 and 4, when pressure is applied to the first and second ends 120, 122 of the U-shaped connector 118, the distance between blades 104, 106 is decreased to allow the blades 104, 106 to be separated by a distance equivalent to the opening in a cell 140 within a plastic six pack. The first and second blades 104, 106 are manipulated so that they extend down first and second interior sidewalls (not shown) of a cell 140 and down the exterior of the growth medium 142 surrounding the plant root system out of which a plant or flower 144 extends.

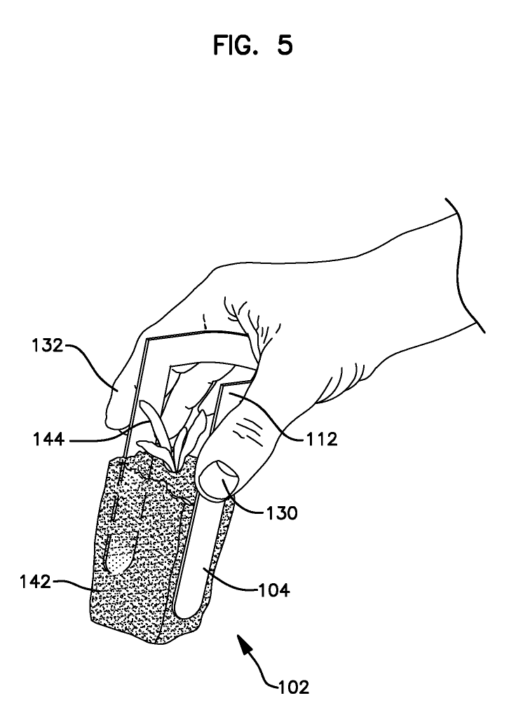

FIG. 5 illustrates removal of the growth medium 142 surrounding the plant root system. As shown, first and second blades 104, 106 apply pressure to the growth medium 142 surrounding the plant root system and upon movement of the apparatus 102 upward and away from the container cell 202, the growth medium 142 surrounding the plant root system is removed from the container cell 202.

Reference has been made throughout this specification to “one embodiment,” “an embodiment,” or “an example embodiment” meaning that a particular described feature, structure, or characteristic is included in at least one embodiment of the present invention. Thus, usage of such phrases may refer to more than just one embodiment. Furthermore, the described features, structures, or characteristics may be combined in any suitable manner in one or more embodiments.

One skilled in the relevant art may recognize, however, that the invention may be practiced without one or more of the specific details, or with other methods, resources, materials, etc. In other instances, well known structures, resources, or operations have not been shown or described in detail merely to avoid obscuring aspects of the invention.

While example embodiments and applications of the present invention have been illustrated and described, it is to be understood that the invention is not limited to the precise configuration and resources described above. Various modifications, changes, and variations apparent to those skilled in the art may be made in the arrangement, operation, and details of the methods and systems of the present invention disclosed herein without departing from the scope of the claimed invention.

1. An apparatus for removing plants from a container comprising:
(a) a first blade having a first end and a second end;
(b) a second blade having a first end and a second end; and
(c) a u-shaped connector body having a first end connected to the second end of the first blade and a second end of the u-shaped connector body connected to the second end of the second blade
wherein the first blade, the second blade and the u-shaped connector are configured as a unitary body whereby the first blade angles inward toward the second blade and the second blade angles inward toward the first blade, causing the distance between the first end of the first blade and the first end of the second blade to be less than the distance between the second end of the first blade and the second end of the second blade.

2. The apparatus of claim 1, wherein the first blade and the second blade have rounded first ends and a thickness that gradually decreases in the direction of the first ends of the first and the second blades so as to facilitate insertion of the first and second blades down a sidewall assembly, whereby the first and second blades are between the interior walls of the sidewall assembly and a growing medium that surrounds a plant root structure.

3. The apparatus of claim 1 wherein the first end of the u-shaped connector body and the second end of the first blade are connected at an angle whereby the first blade extends downward when the u-shaped connector body is positioned horizontally.

4. The apparatus of claim 1 wherein the second end of the u-shaped connector body and the second end of the second blade are connected at an angle whereby the second blade extends downward when the u-shaped connector body is positioned horizontally.

5. The apparatus of claim 1 wherein the apparatus is comprised of a material having a flexibility and memory that allows a reduction in space between the first and second blades upon the application of pressure to the first and second ends of the u-shaped connector.

6. The apparatus of claim 5 wherein the material is comprised of a polymer.

7. The apparatus of claim 5 wherein the material is comprised of a metal.

8. A dual blade plant removal apparatus comprising:
(a) a generally u-shaped connector body comprising a pair of arms extending in a direction such that the arms are substantially parallel, the arms having spaced endings of which are curved through an angle, wherein the curved endings have a first removal blade connected to a first curved ending and a second removal blade connected to a second curved ending, wherein the first and second removal blades extend downward and at an inward angle from the u-shaped connector body, wherein the first removal blade angles inward toward the second removal blade and the second removal blade angles inward toward the first removal blade, causing the distance between the first end of the first removal blade and the first end of the second removal blade to be less than the distance between the second end of the first removal blade and the second end of the second removal blade;
(b) the first removal blade having a first end configured for insertion into a plant container down a sidewall of the plant container and between the sidewall and a growing medium that surrounds a plant root structure; and
(c) the second removal blade having a first end configured for insertion into a plant container down a sidewall of the plant container and between the sidewall and a growing medium that surrounds a plant root structure; wherein the apparatus is comprised of a material that allows the first and second ends of the u-shaped body to be pressed.

9. The first removal blade and the second removal blade of claim 8 extending substantially in parallel.

10. The first removal blade of claim 8 connecting to the first end of the u-shaped body at an angle that allows the first removal blade to extend downward when the u-shaped body is positioned horizontally.

11. The second removal blade of claim 8 connecting to the second end of the u-shaped body at an angle that allows the second removal blade to extend downward when the u-shaped body is positioned horizontally.

12. The first removal blade of claim 8 wherein the first removal blade and the second removal blade are angled on an inward slant consistent with the angle of a sidewall assembly of a plant container cell.

13. A method of removing a plant root system and surrounding growing medium from a plant container that is comprised of a plurality of cells, the method comprising:
(a) extending a first blade down an interior sidewall assembly, wherein the first blade is angled in a manner consistent with the angle of the interior side wall assembly of a cell, wherein the first blade is positioned between the interior sidewall assembly of a cell and the growing medium that surrounds the plant root system;
(b) extending a second blade down the interior sidewall assembly, wherein the second blade is a angled in a manner consistent with the angle of the interior side wall assembly of a cell, wherein the second blade is positioned between the interior sidewall assembly and the growing medium that surrounds the plant root system;
(c) applying pressure to a second end of the first blade and second end of the second blade; and
(d) lifting the growing medium and the plant root system from a cell.
